(19) United States
(12) Patent Application Publication
(10) Pub. No.: US 2025/0175957 A1
(43) Pub. Date: May 29, 2025

(54) SIGNALING FOR AGGREGATED CHANNEL BANDWIDTH FOR CARRIER AGGREGATION

(71) Applicant: QUALCOMM Incorporated, San Diego, CA (US)

(72) Inventors: Bin HAN, Beijing (CN); Mona AGRAWAL, San Diego, CA (US); Masato KITAZOE, Hachiouji-shi, Tokyo (JP); Valentin Alexandru GHEORGHIU, Yokohama-shi, Tokyo (JP); Yiqing CAO, Beijing (CN)

(21) Appl. No.: 18/840,386

(22) PCT Filed: Apr. 22, 2022
(86) PCT No.: PCT/CN2022/088510

§ 371 Date: Aug. 21, 2024

(51) Int. Cl. H04W 72/0453

(52) U.S. Cl. CPC H04W 72/0453

(57) ABSTRACT

Various aspects of the present disclosure generally relate to wireless communication. In some aspects, a user equipment (UE) may transmit, to a network entity, an indication of a supported aggregated bandwidth for carrier aggregation associated with a frequency band combination. The UE may receive, from the network entity, a carrier aggregation configuration, associated with the frequency band combination, that is based at least in part on the supported aggregated bandwidth. Numerous other aspects are described.

### FIELD OF THE DISCLOSURE

Aspects of the present disclosure generally relate to wireless communication and to techniques and apparatuses for signaling for an aggregated channel bandwidth for carrier aggregation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The user equipment may include a memory and one or more processors coupled to the memory. The one or more processors may be configured to transmit, to a network entity, an indication of a supported aggregated bandwidth for carrier aggregation associated with a frequency band combination. The one or more processors may be configured to receive, from the network entity, a carrier aggregation configuration, associated with the frequency band combination, that is based at least in part on the supported aggregated bandwidth.

Some aspects described herein relate to a network entity for wireless communication. The network entity may include a memory and one or more processors coupled to the memory. The one or more processors may be configured to receive an indication of a supported aggregated bandwidth associated with a UE for carrier aggregation associated with a frequency band combination. The one or more processors may be configured to transmit a carrier aggregation configuration for the UE, associated with the frequency band combination, that is based at least in part on the supported aggregated bandwidth.

Some aspects described herein relate to a method of wireless communication performed by a UE. The method may include transmitting, to a network entity, an indication of a supported aggregated bandwidth for carrier aggregation associated with a frequency band combination. The method may include receiving, from the network entity, a carrier aggregation configuration, associated with the frequency band combination, that is based at least in part on the supported aggregated bandwidth.

Some aspects described herein relate to a method of wireless communication performed by a network entity. The method may include receiving an indication of a supported aggregated bandwidth associated with a UE for carrier aggregation associated with a frequency band combination. The method may include transmitting a carrier aggregation configuration for the UE, associated with the frequency band combination, that is based at least in part on the supported aggregated bandwidth.

Some aspects described herein relate to a non-transitory computer-readable medium that stores a set of instructions for wireless communication by a UE. The set of instructions, when executed by one or more processors of the UE, may cause the UE to transmit, to a network entity, an indication of a supported aggregated bandwidth for carrier aggregation associated with a frequency band combination. The set of instructions, when executed by one or more processors of the UE, may cause the UE to receive, from the network entity, a carrier aggregation configuration, associated with the frequency band combination, that is based at least in part on the supported aggregated bandwidth.

Some aspects described herein relate to a non-transitory computer-readable medium that stores a set of instructions for wireless communication by a network entity. The set of instructions, when executed by one or more processors of the network entity, may cause the network entity to receive an indication of a supported aggregated bandwidth associated with a UE for carrier aggregation associated with a frequency band combination. The set of instructions, when executed by one or more processors of the network entity, may cause the network entity to transmit a carrier aggregation configuration for the UE, associated with the frequency band combination, that is based at least in part on the supported aggregated bandwidth.

Some aspects described herein relate to an apparatus for wireless communication. The apparatus may include means for transmitting, to a network entity, an indication of a supported aggregated bandwidth for carrier aggregation associated with a frequency band combination. The apparatus may include means for receiving, from the network entity, a carrier aggregation configuration, associated with the frequency band combination, that is based at least in part on the supported aggregated bandwidth.

Some aspects described herein relate to an apparatus for wireless communication. The apparatus may include means for receiving an indication of a supported aggregated bandwidth associated with a UE for carrier aggregation associated with a frequency band combination. The apparatus may include means for transmitting a carrier aggregation configuration for the UE, associated with the frequency band combination, that is based at least in part on the supported aggregated bandwidth.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of carrier aggregation, in accordance with the present disclosure.

FIG. 5 is a diagram of an example associated with signaling for an aggregated channel bandwidth for carrier aggregation, in accordance with the present disclosure.

FIG. 6 is a diagram illustrating an example process performed, for example, by a UE, in accordance with the present disclosure.

FIG. 7 is a diagram illustrating an example process performed, for example, by a network entity, in accordance with the present disclosure.

FIG. 8 is a diagram of an example apparatus for wireless communication.

FIG. 9 is a diagram of an example apparatus for wireless communication.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

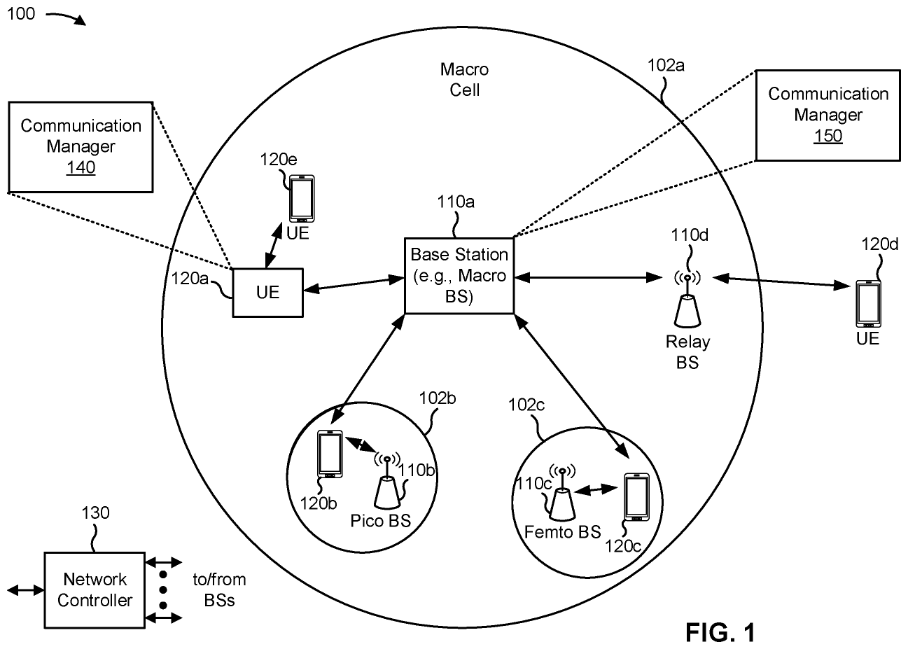

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (for example, the base station 110) or “network entity” may refer to an aggregated base station, a disaggregated base station, an integrated access and backhaul (IAB) node, a relay node, or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band

frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a network entity, an indication of a supported aggregated bandwidth for carrier aggregation associated with a frequency band combination; and receive, from the network entity, a carrier aggregation configuration, associated with the frequency band combination, that is based at least in part on the supported aggregated bandwidth. Additionally, or alternatively, the communication manager 140 may perform one or more other operations described herein.

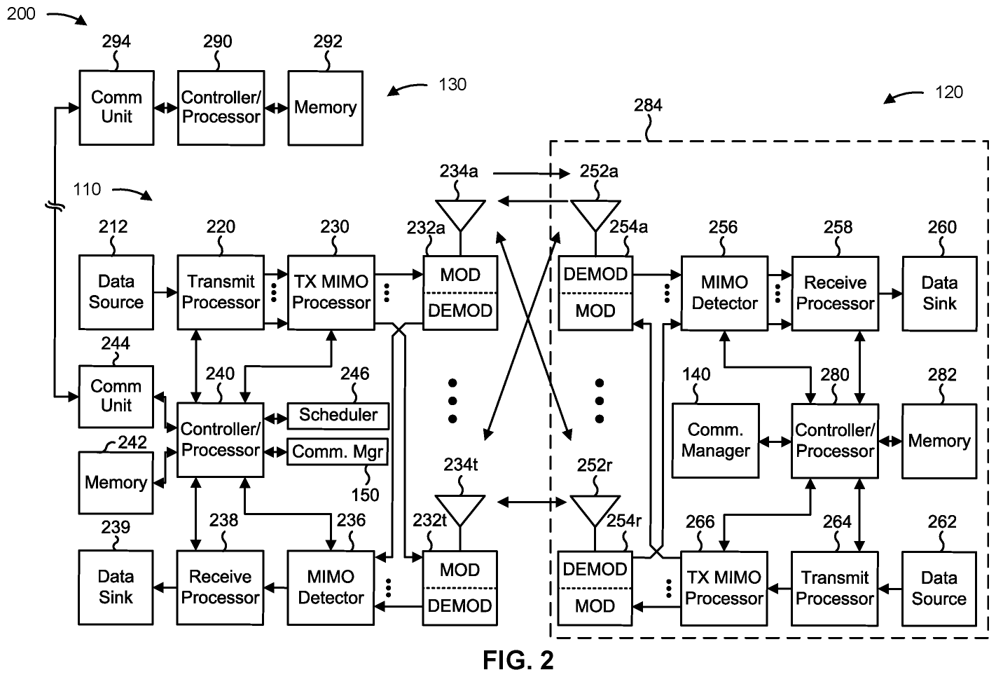

In some aspects, the network entity (e.g., shown as a base station 110 in FIGS. 1 and 2 as an example) may include a communication manager 150. As described in more detail elsewhere herein, the communication manager 150 may receive an indication of a supported aggregated bandwidth associated with a UE for carrier aggregation associated with a frequency band combination; and transmit a carrier aggregation configuration for the UE, associated with the frequency band combination, that is based at least in part on the supported aggregated bandwidth. Additionally, or alternatively, the communication manager 150 may perform one or more other operations described herein.

As indicated above, FIG. 1 is provided as an example. Other examples may differ from what is described with regard to FIG. 1.

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

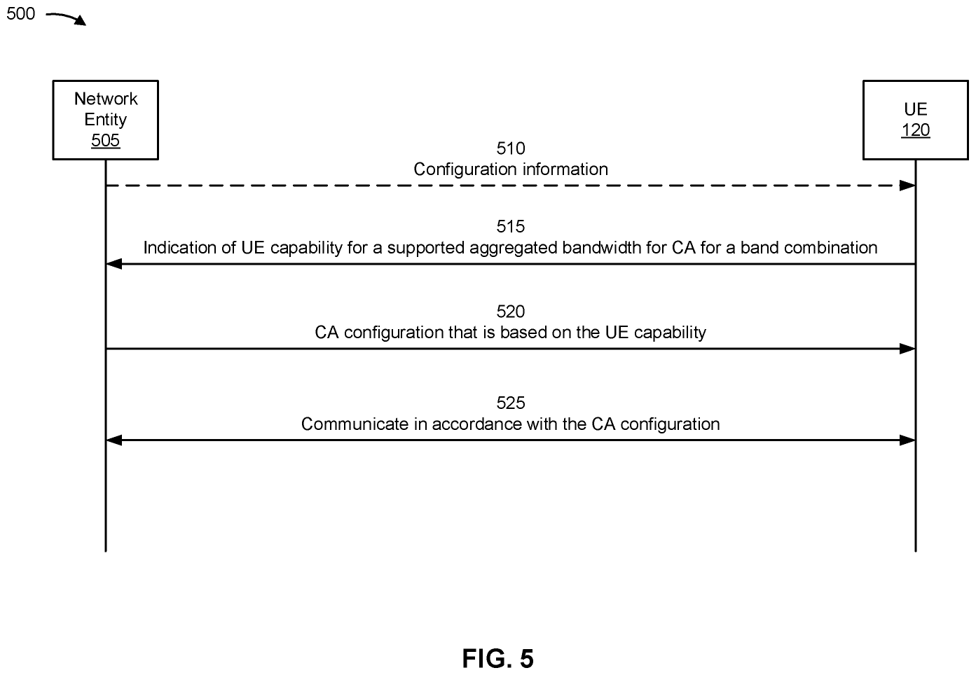

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

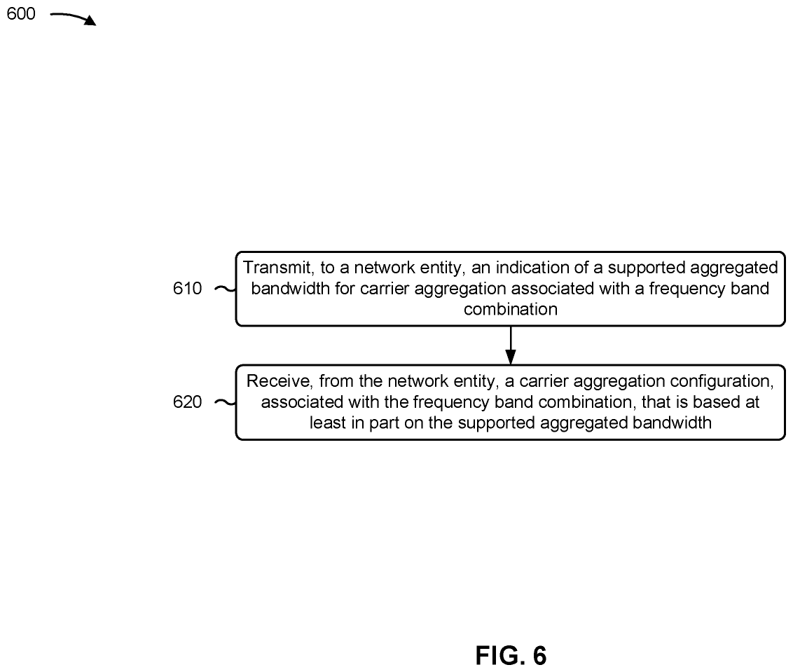

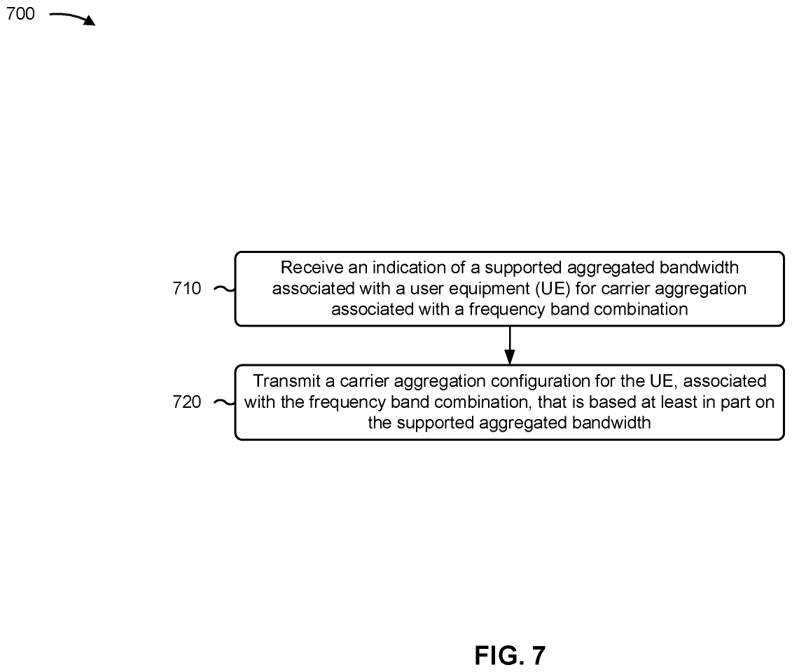

The controller/processor 240 of the base station 110, the controller/processor 280 of the UE 120, and/or any other component(s) of FIG. 2 may perform one or more techniques associated with signaling for an aggregated channel bandwidth for carrier aggregation, as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for transmitting, to a network entity, an indication of a supported aggregated bandwidth for carrier aggregation associated with a frequency band combination; and/or means for receiving, from the network entity, a carrier aggregation configuration, associated with the frequency band combination, that is based at least in part on the supported aggregated bandwidth. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity includes means for receiving an indication of a supported aggregated bandwidth associated with a UE for carrier aggregation associated with a frequency band combination; and/or means for transmitting a carrier aggregation configuration for the UE, associated with the frequency band combination, that is based at least in part on the supported aggregated bandwidth. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station.

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as a CU, one or more DUs, or one or more RUs). In some examples, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

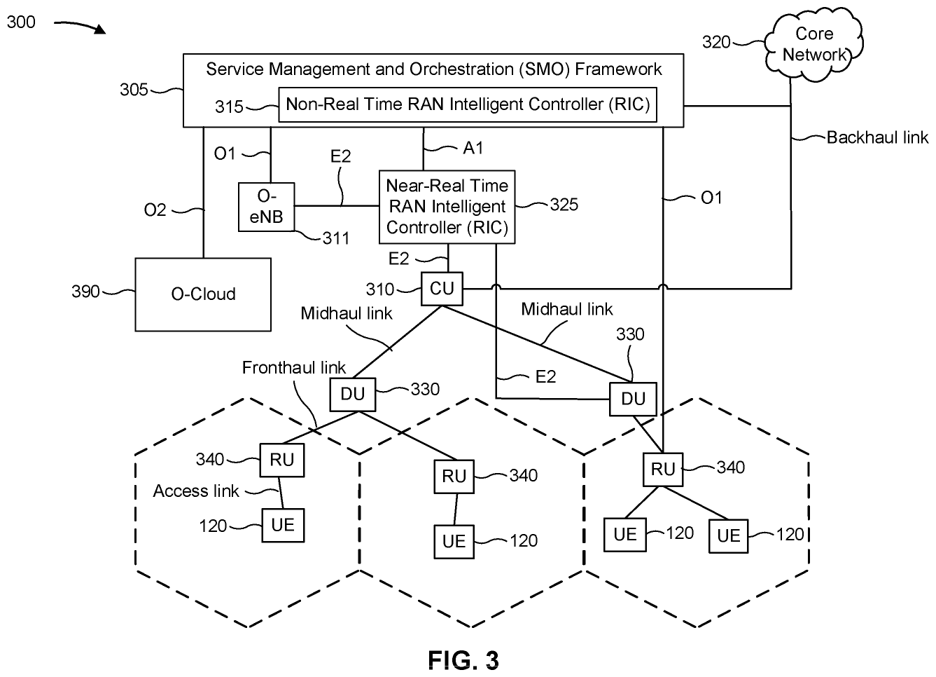

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

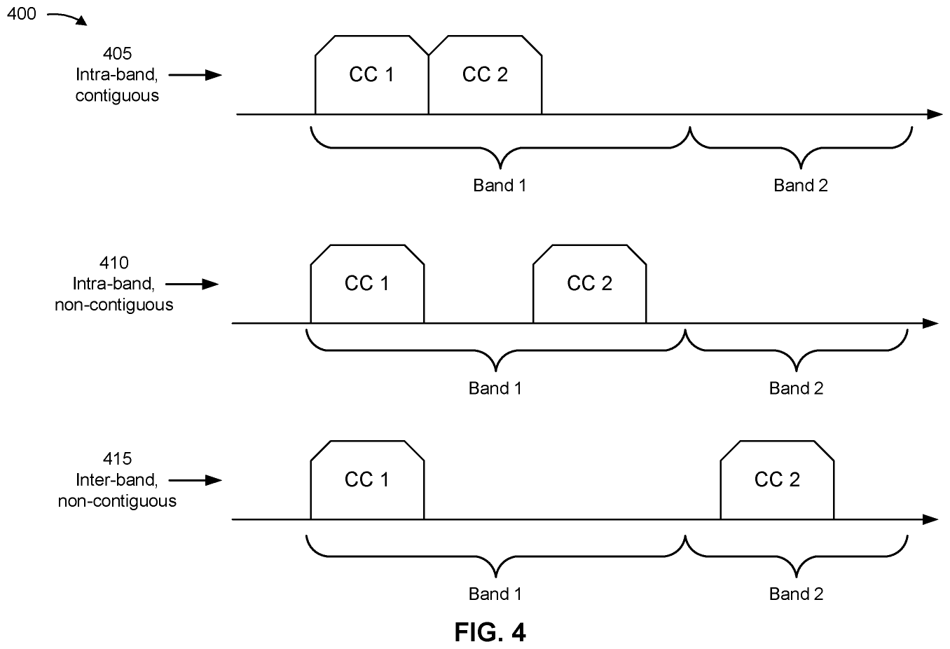

FIG. 4 is a diagram illustrating examples 400 of carrier aggregation, in accordance with the present disclosure.

Carrier aggregation is a technology that enables two or more component carriers (CCs) to be combined (e.g., into a single channel) for a single UE 120 to enhance data capacity. A CC may also be referred to as a carrier herein. As shown, carriers can be combined in the same or different frequency bands. Additionally, or alternatively, contiguous or non-contiguous carriers can be combined. A network entity may configure carrier aggregation for a UE 120, such as in an RRC message, downlink control information (DCI), and/or another signaling message.

A carrier aggregation configuration may be based on a frequency band combination (e.g., sometimes referred to as a band combination) that is associated with the carrier aggregation. As used herein, “frequency band combination” may refer to one or more frequency bands associated with carrier aggregation. For example, a wireless communication standard, such as the 3GPP, may define various frequency bands and may indicate various carrier aggregation configurations for the band combinations. For example, in 3GPP Technical Specification 38.101-1 Version 17.5.0, different frequency band combinations may be defined, such as CA_n1B, CA_n7B, CA_n48B, CA_n1A-n3A, and/or CA_n1 (2A)-n3B, among other examples (e.g., where CA_n1B is associated with the n1 frequency band and carrier aggregation class B). For intra-band carrier aggregation, a given frequency band combination may include a single frequency band. For inter-band carrier aggregation, a given frequency band combination may include multiple frequency bands.

In some examples, configuration parameters for a carrier aggregation configuration may be different for different frequency band combinations. As an example, different channel bandwidths for carriers associated with the carrier aggregation may be supported for different frequency band combinations. As another example, a maximum aggregated bandwidth may be different for different frequency band combinations. As used herein, “aggregated bandwidth” may refer to a sum or combination of the bandwidths of all carriers associated with a carrier aggregation operation. For example, if a first carrier (or CC) is associated with a bandwidth of 10 MHz and a second carrier (or CC) is associated with a bandwidth of 15 MHz, then the aggregated bandwidth for the carrier aggregation operation may be 25 MHz (e.g., 10 MHz+15 MHz). The maximum aggregated bandwidth may be defined, or otherwise fixed, by a wireless communication standard, such as the 3GPP. For example, 3GPP Technical Specification 38.101-1 Version 17.5.0 may define maximum aggregated bandwidths for various frequency band combinations.

Additionally, or alternatively, the maximum aggregated bandwidth may be based on a carrier aggregation class (e.g., associated with a given frequency band). A carrier aggregation class may define a minimum aggregated channel bandwidth, the maximum aggregated channel bandwidth, and/or a number of carriers (or CCs). For example, carrier aggregation classes may be defined, or otherwise fixed, by a wireless communication standard, such as the 3GPP (e.g., such as by 3GPP Technical Specification 38.101-1 Version 17.5.0). As an example, carrier aggregation class B (e.g., as defined, or otherwise fixed, by the 3GPP) may be associated with aggregated bandwidths between 20 MHz and 100 MHz by the aggregation of two carriers (e.g., from the aggregation of two radio channels). As another example, carrier aggregation class D (e.g., as defined, or otherwise fixed, by the 3GPP) may be associated with aggregated bandwidths between 200 MHz and 300 MHz by the aggregation of three carriers (e.g., from the aggregation of three radio channels).

As shown by reference number 405, in some examples, carrier aggregation may be configured in an intra-band contiguous mode where the aggregated carriers are contiguous to one another and are in the same band. As shown by reference number 410, in some examples, carrier aggregation may be configured in an intra-band non-contiguous mode where the aggregated carriers are non-contiguous to one another and are in the same band. As shown by reference number 415, in some examples, carrier aggregation may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). In some examples, the primary carrier may carry control information (e.g., downlink control information and/or scheduling information) for scheduling data communications on one or more secondary carriers, which may be referred to as cross-carrier scheduling. In some examples, a carrier (e.g., a primary carrier or a secondary carrier) may carry control information for scheduling data communications on the carrier, which may be referred to as self-carrier scheduling or carrier self-scheduling.

In some cases, the UE 120 may transmit an indication of one or more capabilities of the UE 120 associated with carrier aggregation. For example, the UE 120 may transmit, to a network entity, an indication of one or more frequency band combinations that the UE 120 supports being configured with carrier aggregation. In some examples, the UE 120 may transmit an indication of a bandwidth combination set (BCS) supported by the UE 120 for a given frequency band combination. For example, a wireless communication standard, such as the 3GPP (e.g., such as in 3GPP Technical Specification 38.101-1 Version 17.5.0) may define supported channel or carrier bandwidths and a maximum aggregated bandwidth for a given frequency band combination and a given BCS. For example, a first set of supported channel or carrier bandwidths and a first maximum aggregated bandwidth for a given frequency band combination and a first BCS, a second set of supported channel or carrier bandwidths and a second maximum aggregated bandwidth for the given frequency band combination and a second BCS, and so on. As an example, for frequency band combination n48, carrier aggregation class B, and a BCS 2 (BCS2), supported bandwidths for a first carrier may include {10 MHz, 15 MHZ, 20 MHZ, 30 MHz, 40 MHz}, supported bandwidths for a second carrier may include {10 MHz, 15 MHz, 20 MHz, 30 MHz, 40 MHz, 50 MHz, 60 MHz, 70 MHz, 80 MHz, and 90 MHz}, and a maximum aggregated bandwidth may be 100 MHz. In the example above, the network entity may refrain from configuring channel bandwidth combinations for the two carriers of 15+90, 20+90, 30+80, 30+90, 40+70, 40+80 and 40+90 because these combinations will equal or exceed the defined maximum aggregated bandwidth of 100 MHz. The UE 120 may transmit an indication of a supported BCS for a given frequency band combination to indicate which set of supported channel or carrier bandwidths and/or which maximum aggregated bandwidth is supported by the UE 120 for carrier aggregation associated with a given frequency band combination.

However, the use of a BCS may introduce additional complexities as new parameters for different BCSs may need to be defined and/or agreed upon (e.g., by the 3GPP) each time a new band combination and/or a new channel bandwidth for a band combination is introduced to be used in a wireless communication network. Therefore, a BCS was introduced that, when reported by a UE 120 associated with a given frequency band combination, indicates that all possible channel bandwidths that are defined for the given frequency band combination are supported by the UE 120 (e.g., BCS4, BCS5, and/or other similar BCSs as defined, or otherwise fixed, by the 3GPP). For example, bandwidth combination set 4 and 5 may contain all possible defined channel bandwidths for each band in the combination.

However, in some cases, one or more combinations of supported bandwidths for a given frequency band combination and/or carrier aggregation class may be associated with a possible aggregated channel bandwidth that equals or exceeds an aggregated channel bandwidth supported by the UE 120. In other words, the UE 120 may support all possible defined channel bandwidths for each band in the combination, but not all combinations of supported bandwidths for each band in the combination. For example, for the frequency band combination n7B, it may be possible to define carrier bandwidths that combine up to 70 MHz (e.g., by aggregating a first carrier associated with a 30 MHz bandwidth and a second carrier associated with a 40 MHz bandwidth), but the UE 120 may only support a maximum aggregated bandwidth of 50 MHz. In such examples, the UE 120 may transmit, to the network entity, an indication of one or more feature sets from the possible defined channel bandwidths for each band in the combination. A feature set may also be referred to as a feature set combination. For example, for the frequency band combination n7B, the UE 120 may transmit a first feature set of ({10, 15, 20}, {10, 15, 20, 30}), a second feature set of ({10, 15}, {10, 15, 20, 30}), and a third feature set of ({10}, {10, 15, 20, 30, 40}). As shown, the indication of the different feature sets may ensure that the network does not configure a carrier aggregation configuration for the frequency band combination n7B that does not exceed the supported maximum aggregated bandwidth of 50 MHz. Feature sets may be reported by the UE 120 for other frequency band combinations in a similar manner as described above. However, reporting different supported feature sets for one or more (or all) supported frequency band combinations may result in significant signaling overhead for the UE 120 and the network entity. In other words, this may increase a signaling overhead associated with configuring carrier aggregation for the UE 120.

Similar problems may exist for other BCSs (e.g., other BCSs that are not associated with indicating that all possible channel bandwidths that are defined for the given frequency band combination are supported by the UE 120, such as BCS0, BCS1, BS2, and/or BCS3) where the UE 120 supports a maximum aggregated channel bandwidth for a given frequency band combination that is less than a maximum aggregated channel bandwidth defined for the given frequency band combination and the BCS (e.g., defined by the 3GPP or another wireless communication standard). In such examples, the UE 120 may transmit, to the network entity, an indication of one or more feature sets of supported carrier bandwidth combinations supported by the UE 120. This may increase a signaling overhead associated with configuring carrier aggregation for the UE 120.

Some techniques and apparatuses described herein enable signaling for an aggregated channel bandwidth for carrier aggregation. For example, the UE 120 may transmit, to a network entity, an indication of a supported aggregated bandwidth (e.g., a supported maximum aggregated bandwidth) for carrier aggregation associated with a frequency band combination. The UE 120 may receive, from the network entity, a carrier aggregation configuration, associated with the frequency band combination, that is based at least in part on the supported aggregated bandwidth. The indication of the supported aggregated bandwidth (e.g., a supported maximum aggregated bandwidth) may be associated with intra-band carrier aggregation (e.g., intra-band contiguous carrier aggregation and/or intra-band non-contiguous carrier aggregation) and/or inter-band carrier aggregation. In some aspects, the UE 120 may report a maximum aggregated bandwidth supported by the UE 120 per frequency band combination (e.g., separately for one or more, or each, frequency band combination supported by the UE 120).

For example, by reporting the supported aggregated bandwidth (e.g., a supported maximum aggregated bandwidth) for carrier aggregation associated with a frequency band combination, the UE 120 may no longer need to report one or more feature sets of supported carrier bandwidth combinations supported by the UE 120. For example, the network entity may refrain from configuring carriers with bandwidths that combine to equal and/or exceed the indicated supported aggregated bandwidth for the frequency band combination (e.g., because the network entity may now know the supported maximum aggregated bandwidth for the UE 120 for the frequency band combination). As a result, signaling overhead associated with configuring carrier aggregation for the UE 120 may be reduced.

As indicated above, FIG. 4 is provided as an example. Other examples may differ from what is described with regard to FIG. 4.

FIG. 5 is a diagram of an example 500 associated with signaling for an aggregated channel bandwidth for carrier aggregation, in accordance with the present disclosure. As shown in FIG. 5, a network entity 505 (e.g., a base station 110, a CU, a DU, and/or an RU) may communicate with a UE (e.g., a UE 120). In some aspects, the network entity 505 and the UE 120 may be part of a wireless network (e.g., the wireless network 100). The UE 120 and the network entity 505 may have established a wireless connection prior to operations shown in FIG. 5.

In some aspects, as shown by reference number 510, the network entity 505 may transmit configuration information intended for the UE 120. The UE 120 may receive the configuration (e.g., from the network entity 505 or from another network entity). In some aspects, the UE may receive the configuration information via one or more of radio resource control (RRC) signaling, one or more medium access control (MAC) control elements (MAC-CEs), and/or downlink control information (DCI), among other examples. In some aspects, the configuration information may include an indication of one or more configuration parameters (e.g., already stored by the UE 120 and/or previously indicated by the network entity 505 or other network entity) for selection by the UE 120, and/or explicit configuration information for the UE 120 to use to configure the UE 120, among other examples.

In some aspects, the configuration information may indicate that the UE 120 is to report a capability associated with a supported aggregated bandwidth (e.g., a supported maximum aggregated bandwidth) for carrier aggregation associated with a frequency band combination. In some aspects, the configuration information may indicate that the UE 120 is to report a capability associated with a supported aggregated bandwidth per frequency band combination (e.g., separately for one or more, or each, frequency band combination supported by the UE 120). In some aspects, the configuration information may indicate that the UE 120 is to report a capability associated with a supported aggregated bandwidth when a defined or fixed (e.g., by a wireless communication standard, such as the 3GPP) aggregated bandwidth for a frequency band combination is greater than the supported aggregated bandwidth. In some aspects, the configuration information may indicate that the UE 120 is to report a capability associated with a supported aggregated bandwidth for a frequency band combination when the UE 120 supports certain BCSs for the frequency band combination (e.g., BCSs that are associated with indicating that the UE 120 supports all possible channel bandwidths that are defined for the given frequency band combination, such as BCS4 and/or BCS5).

In some aspects, the configuration information may indicate that the UE 120 is to report a capability associated with a supported aggregated bandwidth for intra-band carrier aggregation. In some aspects, the configuration information may indicate that the UE 120 is to report a capability associated with a supported aggregated bandwidth for intra-band contiguous carrier aggregation. Additionally, or alternatively, the configuration information may indicate that the UE 120 is to report a capability associated with a supported aggregated bandwidth for intra-band non-contiguous carrier aggregation. Additionally, or alternatively, the configuration information may indicate that the UE 120 is to report a capability associated with a supported aggregated bandwidth for inter-band carrier aggregation. In some aspects, the configuration information may indicate that the UE 120 is to report separate supported aggregated bandwidths for intra-band carrier aggregation and inter-band carrier aggregation (e.g., a first supported aggregated bandwidth for intra-band carrier aggregation and a second supported aggregated bandwidth for inter-band carrier aggregation) for a given frequency band combination.

The UE 120 may configure itself based at least in part on the configuration information. In some aspects, the UE 120 may be configured to perform one or more operations described herein based at least in part on the configuration information.

As shown by reference number 515, the UE 120 may transmit an indication of a supported aggregated bandwidth for carrier aggregation associated with a frequency band combination (e.g., to the network entity 505 or another network entity). The network entity 505 may receive the indication of the supported aggregated bandwidth for carrier aggregation associated with the frequency band combination (e.g., from the UE 120 or from another network entity). The UE 120 may transmit the indication via a capabilities report. In some aspects, the capabilities report may indicate UE support for the supported aggregated bandwidth for carrier aggregation associated with the frequency band combination. In some aspects, the indication of the supported aggregated bandwidth for carrier aggregation associated with the frequency band combination may be transmitted via, or included in, an uplink communication, an uplink control channel communication (e.g., a physical uplink control channel (PUCCH) communication), an RRC communication, a UE capability report, UE capability signaling, a UE assistance information (UAI) communication, Layer 1 signaling, Layer 2 signaling, and/or Layer 3 signaling, among other examples.

In some aspects, the supported aggregated bandwidth may be associated with intra-band carrier aggregation. For example, a capability parameter may be defined that is associated with indicating a maximum aggregated bandwidth for intra-band carrier aggregation (e.g., for intra-band contiguous and/or intra-band non-contiguous carrier aggregation) for a given band combination (e.g., a ca-intrabandMaxAggregatedBandwidth-NR parameter). The UE 120 may include the capability parameter in a communication to indicate the supported aggregated bandwidth for intra-band carrier aggregation associated with a frequency band combination. As another example, a capability parameter may be defined that is associated with indicating a maximum aggregated bandwidth for inter-band carrier aggregation for a given band combination (e.g., a ca-interbandMaxAggregatedBandwidth-NR parameter). The UE 120 may include the capability parameter in a communication to indicate the supported aggregated bandwidth for inter-band carrier aggregation associated with a frequency band combination. In other words, in some aspects, the UE 120 may report separate capabilities for support aggregated bandwidths for intra-band carrier aggregation and inter-band carrier aggregation.

In some aspects, the UE 120 may report the capability for supported aggregated bandwidths for carrier aggregation per band combination. For example, the UE 120 may transmit a first indication of a first supported aggregated bandwidth associated with a first frequency band combination. The UE 120 may transmit (e.g., in the same communication or another communication) a second indication (e.g., another indication) of a second supported aggregated bandwidth (e.g., another supported aggregated bandwidth) associated with a second frequency band combination (e.g., another frequency band combination).

In some aspects, the UE 120 may transmit the indication of the supported aggregated bandwidth associated with the frequency band combination based at least in part on the supported aggregated bandwidth being less than a maximum aggregated bandwidth associated with a BCS supported by the UE 120 for the frequency band combination. For example, the UE 120 may transmit an indication of a BCS associated with the carrier aggregation associated with the frequency band combination. The BCS may be associated with another aggregated bandwidth for the carrier aggregation associated with the frequency band combination (e.g., as defined, or otherwise fixed, by a wireless communication standard, such as the 3GPP). The supported aggregated bandwidth may be less than the other aggregated bandwidth (e.g., that is defined, or otherwise fixed, by the BCS and the frequency band combination). For example, a given frequency band combination may be associated with carrier bandwidths that, when combined, may total an aggregated bandwidth of 100 MHz. If the UE 120 supports all possible carrier bandwidths for the given frequency band combination, then the UE 120 may transmit an indication that a BCS4 or BCS5 (or another similar BCS) is supported for the given frequency band combination. However, the UE 120 may only support a maximum aggregated bandwidth of 50 MHz for the given frequency band combination. Therefore, the UE 120 may transmit the indication of the supported aggregated bandwidth (e.g., 50 MHz) for the given frequency band combination.

As another example, the UE 120 may transmit the indication of the supported aggregated bandwidth associated with the frequency band combination based at least in part on the supported aggregated bandwidth being less than a maximum aggregated bandwidth associated with a carrier aggregation class associated with the frequency band combination. For example, the frequency band combination may be associated with the carrier aggregation class (e.g., as defined, or otherwise fixed, by a wireless communication standard, such as the 3GPP). The carrier aggregation class may be associated with another aggregated bandwidth for the carrier aggregation associated with the frequency band combination (e.g., as defined, or otherwise fixed, by a wireless communication standard, such as the 3GPP). The supported aggregated bandwidth may be less than the other aggregated bandwidth (e.g., that is defined, or otherwise fixed, by the carrier aggregation class). For example, a carrier aggregation class B may be associated with a maximum aggregated bandwidth of 100 MHz (e.g., as defined, or otherwise fixed, by a wireless communication standard, such as the 3GPP). However, the UE 120 may only support a maximum aggregated bandwidth of 50 MHz for a given frequency band combination associated with the carrier aggregation class B. Therefore, the UE 120 may transmit the indication of the supported aggregated bandwidth (e.g., 50 MHz) for the given frequency band combination associated with the carrier aggregation class B.

In some aspects, in addition to the supported aggregated bandwidth associated with the frequency band combination, the UE 120 may transmit an indication of a minimum channel bandwidth for a single carrier or CC and a maximum channel bandwidth for a single carrier or CC for carrier aggregation associated with the frequency band combination. For example, the UE 120 may transmit an indication of the supported aggregated bandwidth, a minimum carrier bandwidth, and/or a maximum carrier bandwidth for carrier aggregation associated with the frequency band combination. As an example, for the frequency band combination n7B, the UE 120 may indicate that the supported aggregated bandwidth is 50 MHz, the minimum carrier bandwidth is 10 MHz, and the maximum carrier bandwidth is 40 MHz. As another example, for the frequency band combination n1, the UE 120 may indicate that the supported aggregated bandwidth is 100 MHz, the minimum carrier bandwidth is 20 MHz, and the maximum carrier bandwidth is 50 MHz. As yet another example, for the frequency band combination n78, the UE 120 may indicate that the supported aggregated bandwidth is 100 MHz, the minimum carrier bandwidth is 50 MHz, and the maximum carrier bandwidth is 80 MHz. Based at least in part on this reported information, the network entity 505 may be enabled to configure carrier aggregation for the UE 120 for the frequency band combination without exceeding the supported aggregated bandwidth (e.g., and without requiring the UE 120 to report an indication of one or more feature sets supported by the UE 120 associated with the frequency band combination, thereby reducing a signaling overhead associated with configuring carrier aggregation for the frequency band combination).

As shown by reference number 520, the network entity 505 may transmit (e.g., to the UE 120 or to another network entity) a carrier aggregation configuration intended for the UE 120, associated with the frequency band combination, that is based at least in part on the supported aggregated bandwidth. The UE 120 may receive the carrier aggregation configuration (e.g., from the network entity 505 or from another network entity). In some aspects, the UE 120 may receive the carrier aggregation configuration via one or more of RRC signaling, one or more MAC-CEs, and/or DCI, among other examples. In some aspects, the carrier aggregation configuration may include an indication of one or more configuration parameters (e.g., already stored by the UE 120 and/or previously indicated by the network entity 505 or other network entity) for selection by the UE 120, and/or explicit configuration information for the UE 120 to use to configure the UE 120, among other examples

The carrier aggregation may indicate two or more carriers that are configured for the UE 120 for carrier aggregation (e.g., associated with the frequency band combination). For example, the carrier aggregation configuration may indicate a bandwidth and/or a frequency domain location associated with each configured carrier, among other configuration parameters.

In some aspects, the network entity 505 may determine the carrier aggregation configuration based at least in part on the supported aggregated bandwidth for the frequency band combination (e.g., that is reported by the UE 120). For example, the network entity 505 may determine channel bandwidths for carriers associated with carrier aggregation for the frequency band combination based at least in part on the supported aggregated bandwidth. For example, the network entity 505 may select channel bandwidths for carriers associated with carrier aggregation from bandwidths associated with the frequency band combination (e.g., as defined, or otherwise fixed, by a wireless communication standard, such as the 3GPP). The network entity 505 may select the channel bandwidths for the carriers while ensuring that a sum or aggregate of the channel bandwidths does not equal or exceed the supported aggregated bandwidth (e.g., reported by the UE 120 as described elsewhere herein) for the frequency band combination. For example, in some aspects, the carrier aggregation configuration may be associated with a first carrier associated with a first bandwidth and a second carrier associated with a second bandwidth. The network entity 505 may determine the carrier aggregation configuration such that a sum of the first bandwidth and the second bandwidth is less than or equal to the supported aggregated bandwidth. The network entity 505 may determine the carrier aggregation configuration to be associated with more than two carriers in a similar manner.

The UE 120 may configure the carriers for carrier aggregation associated with the frequency band combination based at least in part on receiving the carrier aggregation configuration. For example, for intra-band carrier aggregation, the UE 120 may configure the carriers within the same frequency band. For inter-band carrier aggregation, the UE 120 may configure the carriers within different frequency bands.

As shown by reference number 525, the UE 120 and the network entity 505 may communicate in accordance with the carrier aggregation configuration. For example, the UE 120 may transmit (e.g., to the network entity 505 or another network entity) one or more uplink signals in accordance with the carrier aggregation configuration (e.g., using one or more of the carriers configured by the carrier aggregation configuration). The network entity 505 may receive (e.g., from the UE 120 or another network entity) the one or more uplink signals in accordance with the carrier aggregation configuration. As another example, the UE 120 may receive (e.g., from the network entity 505 or another network entity) one or more downlink signals in accordance with the carrier aggregation configuration. The network entity 505 may transmit (e.g., to the UE 120 or another network entity) the one or more downlink signals in accordance with the carrier aggregation configuration. In other words, the carrier aggregation configuration may be associated with uplink carrier aggregation and/or downlink carrier aggregation.

By enabling the UE 120 to report the supported aggregated bandwidth (e.g., a supported maximum aggregated bandwidth) for carrier aggregation associated with a frequency band combination, the UE 120 may no longer need to report one or more feature sets of supported carrier bandwidth combinations supported by the UE 120. For example, the network entity 505 may refrain from configuring carriers with bandwidths that combine to equal and/or exceed the indicated supported aggregated bandwidth for the frequency band combination (e.g., because the network entity 505 may now know the supported maximum aggregated bandwidth for the UE 120 for the frequency band combination). As a result, signaling overhead associated with configuring carrier aggregation for the UE 120 may be reduced.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., the UE 120) performs operations associated with signaling for an aggregated channel bandwidth for carrier aggregation.

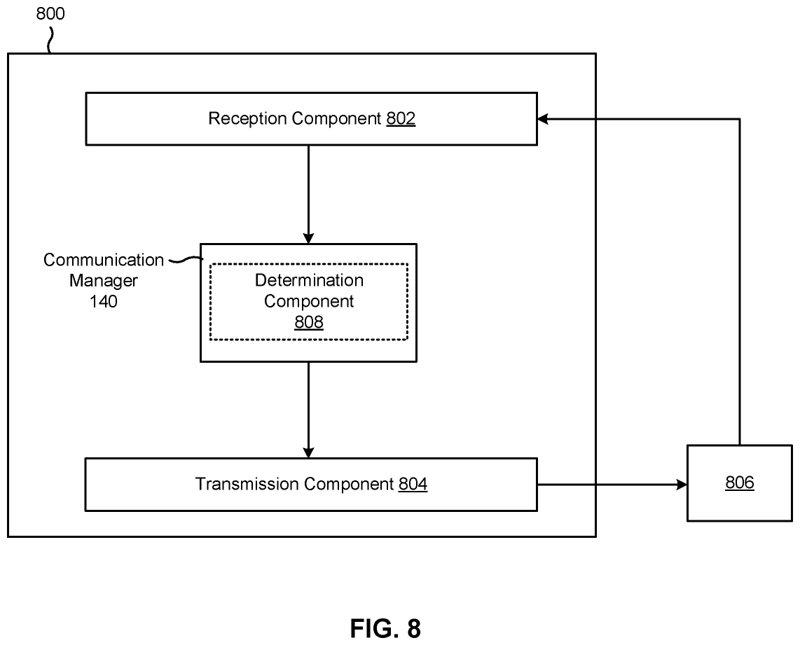

As shown in FIG. 6, in some aspects, process 600 may include transmitting, to a network entity, an indication of a supported aggregated bandwidth for carrier aggregation associated with a frequency band combination (block 610). For example, the UE (e.g., using communication manager 140 and/or transmission component 804, depicted in FIG. 8) may transmit, to a network entity, an indication of a supported aggregated bandwidth for carrier aggregation associated with a frequency band combination, as described above.

As further shown in FIG. 6, in some aspects, process 600 may include receiving, from the network entity, a carrier aggregation configuration, associated with the frequency band combination, that is based at least in part on the supported aggregated bandwidth (block 620). For example, the UE (e.g., using communication manager 140 and/or reception component 802, depicted in FIG. 8) may receive, from the network entity, a carrier aggregation configuration, associated with the frequency band combination, that is based at least in part on the supported aggregated bandwidth, as described above.

Process 600 may include additional aspects, such as any single aspect or any combination of aspects described below and/or in connection with one or more other processes described elsewhere herein.

In a first aspect, process 600 includes transmitting one or more uplink signals in accordance with the carrier aggregation configuration.

In a second aspect, alone or in combination with the first aspect, process 600 includes receiving one or more downlink signals in accordance with the carrier aggregation configuration.

In a third aspect, alone or in combination with one or more of the first and second aspects, process 600 includes transmitting, to the network entity, an indication of another supported aggregated bandwidth for carrier aggregation associated with another frequency band combination.

In a fourth aspect, alone or in combination with one or more of the first through third aspects, the supported aggregated bandwidth is associated with a capability of the UE.

In a fifth aspect, alone or in combination with one or more of the first through fourth aspects, the indication of the supported aggregated bandwidth is included in at least one of a UE capability report, UE capability signaling, or a UAI communication.

In a sixth aspect, alone or in combination with one or more of the first through fifth aspects, the supported aggregated bandwidth is associated with intra-band carrier aggregation.

In a seventh aspect, alone or in combination with one or more of the first through sixth aspects, the intra-band carrier aggregation includes at least one of intra-band contiguous carrier aggregation or intra-band non-contiguous carrier aggregation.

In an eighth aspect, alone or in combination with one or more of the first through seventh aspects, the supported aggregated bandwidth is associated with inter-band carrier aggregation.

In a ninth aspect, alone or in combination with one or more of the first through eighth aspects, the supported aggregated bandwidth is a maximum aggregated bandwidth supported by the UE for the carrier aggregation associated with the frequency band combination.

In a tenth aspect, alone or in combination with one or more of the first through ninth aspects, process 600 includes transmitting, to the network entity, an indication of a BCS associated with the carrier aggregation associated with the frequency band combination, wherein the BCS is associated with another aggregated bandwidth for the carrier aggregation associated with the frequency band combination, and wherein the supported aggregated bandwidth is less than the other aggregated bandwidth.

In an eleventh aspect, alone or in combination with one or more of the first through tenth aspects, the frequency band combination is associated with a carrier aggregation class, wherein the carrier aggregation class is associated with another aggregated bandwidth for the carrier aggregation associated with the frequency band combination, and wherein the supported aggregated bandwidth is less than the other aggregated bandwidth.

In a twelfth aspect, alone or in combination with one or more of the first through eleventh aspects, the carrier aggregation configuration is associated with a first carrier associated with a first bandwidth and a second carrier associated with a second bandwidth, and a sum of the first bandwidth and the second bandwidth is less than or equal to the supported aggregated bandwidth.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network entity, in accordance with the present disclosure. Example process 700 is an example where the network entity (e.g., the network entity 505, a base station 110, a CU, a DU, and/or an RU) performs operations associated with signaling for an aggregated channel bandwidth for carrier aggregation.

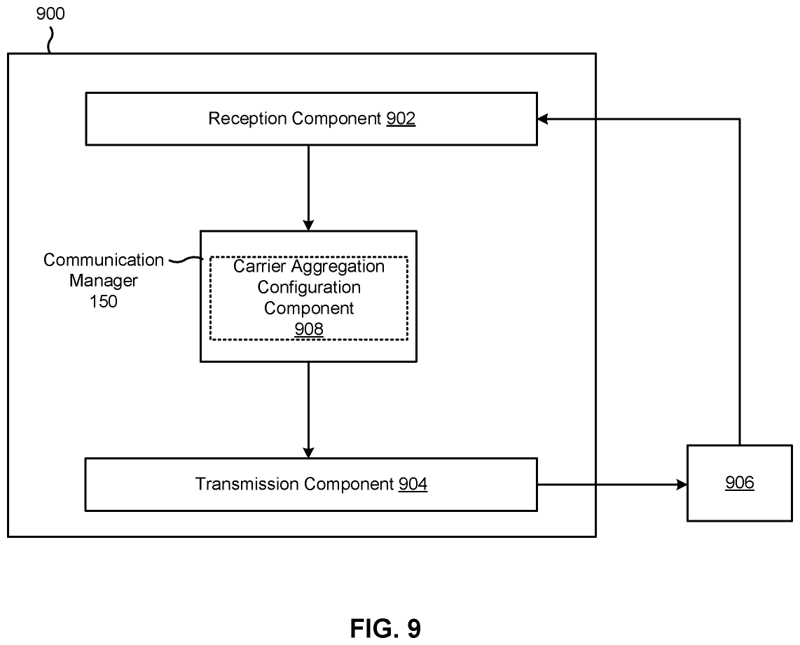

As shown in FIG. 7, in some aspects, process 700 may include receiving an indication of a supported aggregated bandwidth associated with a UE for carrier aggregation associated with a frequency band combination (block 710). For example, the network entity (e.g., using communication manager 150 and/or reception component 902, depicted in FIG. 9) may receive an indication of a supported aggregated bandwidth associated with a UE for carrier aggregation associated with a frequency band combination, as described above.

As further shown in FIG. 7, in some aspects, process 700 may include transmitting a carrier aggregation configuration for the UE, associated with the frequency band combination, that is based at least in part on the supported aggregated bandwidth (block 720). For example, the network entity (e.g., using communication manager 150 and/or transmission component 904, depicted in FIG. 9) may transmit a carrier aggregation configuration for the UE, associated with the frequency band combination, that is based at least in part on the supported aggregated bandwidth, as described above.

Process 700 may include additional aspects, such as any single aspect or any combination of aspects described below and/or in connection with one or more other processes described elsewhere herein.

In a first aspect, process 700 includes receiving one or more uplink signals in accordance with the carrier aggregation configuration.

In a second aspect, alone or in combination with the first aspect, process 700 includes transmitting one or more downlink signals in accordance with the carrier aggregation configuration.

In a third aspect, alone or in combination with one or more of the first and second aspects, process 700 includes receiving an indication of another supported aggregated bandwidth associated with the UE for carrier aggregation associated with another frequency band combination.

In a fourth aspect, alone or in combination with one or more of the first through third aspects, the supported aggregated bandwidth is associated with a capability of the UE.

In a fifth aspect, alone or in combination with one or more of the first through fourth aspects, the indication of the supported aggregated bandwidth is included in at least one of a UE capability report, UE capability signaling, or a UAI communication.

In a sixth aspect, alone or in combination with one or more of the first through fifth aspects, the supported aggregated bandwidth is associated with intra-band carrier aggregation.

In a seventh aspect, alone or in combination with one or more of the first through sixth aspects, the intra-band carrier aggregation includes at least one of intra-band contiguous carrier aggregation or intra-band non-contiguous carrier aggregation.

In an eighth aspect, alone or in combination with one or more of the first through seventh aspects, the supported aggregated bandwidth is associated with inter-band carrier aggregation.

In a ninth aspect, alone or in combination with one or more of the first through eighth aspects, the supported aggregated bandwidth is a maximum aggregated bandwidth supported by the UE for the carrier aggregation associated with the frequency band combination.

In a tenth aspect, alone or in combination with one or more of the first through ninth aspects, process 700 includes receiving an indication of a BCS associated with the carrier aggregation associated with the frequency band combination, wherein the BCS is associated with another aggregated bandwidth for the carrier aggregation associated with the frequency band combination, and wherein the supported aggregated bandwidth is less than the other aggregated bandwidth.

In an eleventh aspect, alone or in combination with one or more of the first through tenth aspects, the frequency band combination is associated with a carrier aggregation class, wherein the carrier aggregation class is associated with another aggregated bandwidth for the carrier aggregation associated with the frequency band combination, and wherein the supported aggregated bandwidth is less than the other aggregated bandwidth.

In a twelfth aspect, alone or in combination with one or more of the first through eleventh aspects, the carrier aggregation configuration is associated with a first carrier associated with a first bandwidth and a second carrier associated with a second bandwidth, and a sum of the first bandwidth and the second bandwidth is less than or equal to the supported aggregated bandwidth.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include a determination component 808, among other examples.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The transmission component 804 may transmit, to a network entity, an indication of a supported aggregated bandwidth for carrier aggregation associated with a frequency band combination. The reception component 802 may receive, from the network entity, a carrier aggregation configuration, associated with the frequency band combination, that is based at least in part on the supported aggregated bandwidth.

The determination component 808 may determine the supported aggregated bandwidth based at least in part on a capability of the apparatus 800.

The transmission component 804 may transmit one or more uplink signals in accordance with the carrier aggregation configuration.

The reception component 802 may receive one or more downlink signals in accordance with the carrier aggregation configuration.

The transmission component 804 may transmit, to the network entity, an indication of another supported aggregated bandwidth for carrier aggregation associated with another frequency band combination.

The transmission component 804 may transmit, to the network entity, an indication of a BCS associated with the carrier aggregation associated with the frequency band combination, wherein the BCS is associated with another aggregated bandwidth for the carrier aggregation associated with the frequency band combination, and wherein the supported aggregated bandwidth is less than the other aggregated bandwidth.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network entity, or a network entity may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include a carrier aggregation configuration component 908, among other examples.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the network entity described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network entity described in connection with FIG. 2 (e.g., where the network entity is shown as a base station 110 as an example).

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the network entity described in connection with FIG. 2 (e.g., where the network entity is shown as a base station 110 as an example). In some aspects, the transmission component 904 may be co-located with the reception component 902 in a transceiver.

The reception component 902 may receive an indication of a supported aggregated bandwidth associated with a UE for carrier aggregation associated with a frequency band combination. The transmission component 904 may transmit a carrier aggregation configuration for the UE, associated with the frequency band combination, that is based at least in part on the supported aggregated bandwidth.

The carrier aggregation configuration component 908 may determine the carrier aggregation configuration based at least in part on the supported aggregated bandwidth. The carrier aggregation configuration component 908 may determine the carrier aggregation configuration such that a sum of bandwidths of carriers associated with the carrier aggregation configuration is less than or equal to the supported aggregated bandwidth.

The reception component 902 may receive one or more uplink signals in accordance with the carrier aggregation configuration.

The transmission component 904 may transmit one or more downlink signals in accordance with the carrier aggregation configuration.

The reception component 902 may receive an indication of another supported aggregated bandwidth associated with the UE for carrier aggregation associated with another frequency band combination.

The reception component 902 may receive an indication of a BCS associated with the carrier aggregation associated with the frequency band combination, wherein the BCS is associated with another aggregated bandwidth for the carrier aggregation associated with the frequency band combination, and wherein the supported aggregated bandwidth is less than the other aggregated bandwidth.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: transmitting, to a network entity, an indication of a supported aggregated bandwidth for carrier aggregation associated with a frequency band combination; and receiving, from the network entity, a carrier aggregation configuration, associated with the frequency band combination, that is based at least in part on the supported aggregated bandwidth.

Aspect 2: The method of Aspect 1, further comprising: transmitting one or more uplink signals in accordance with the carrier aggregation configuration.

Aspect 3: The method of any of Aspects 1-2, further comprising: receiving one or more downlink signals in accordance with the carrier aggregation configuration.

Aspect 4: The method of any of Aspects 1-3, further comprising: transmitting, to the network entity, an indication of another supported aggregated bandwidth for carrier aggregation associated with another frequency band combination.

Aspect 5: The method of any of Aspects 1-4, wherein the supported aggregated bandwidth is associated with a capability of the UE.

Aspect 6: The method of any of Aspects 1-5, wherein the indication of the supported aggregated bandwidth is included in at least one of: a UE capability report, UE capability signaling, or a UE assistance information (UAI) communication.

Aspect 7: The method of any of Aspects 1-6, wherein the supported aggregated bandwidth is associated with intra-band carrier aggregation.

Aspect 8: The method of Aspect 7, wherein the intra-band carrier aggregation includes at least one of intra-band contiguous carrier aggregation or intra-band non-contiguous carrier aggregation.

Aspect 9: The method of any of Aspects 1-8, wherein the supported aggregated bandwidth is associated with inter-band carrier aggregation.

Aspect 10: The method of any of Aspects 1-9, wherein the supported aggregated bandwidth is a maximum aggregated bandwidth supported by the UE for the carrier aggregation associated with the frequency band combination.

Aspect 11: The method of any of Aspects 1-10, further comprising: transmitting, to the network entity, an indication of a bandwidth combination set (BCS) associated with the carrier aggregation associated with the frequency band combination, wherein the BCS is associated with another aggregated bandwidth for the carrier aggregation associated with the frequency band combination, and wherein the supported aggregated bandwidth is less than the other aggregated bandwidth.

Aspect 12: The method of any of Aspects 1-11, wherein the frequency band combination is associated with a carrier aggregation class, wherein the carrier aggregation class is associated with another aggregated bandwidth for the carrier aggregation associated with the frequency band combination, and wherein the supported aggregated bandwidth is less than the other aggregated bandwidth.

Aspect 13: The method of any of Aspects 1-12, wherein the carrier aggregation configuration is associated with a first carrier associated with a first bandwidth and a second carrier associated with a second bandwidth, and wherein a sum of the first bandwidth and the second bandwidth is less than or equal to the supported aggregated bandwidth.

Aspect 14: A method of wireless communication performed by a network entity, comprising: receiving an indication of a supported aggregated bandwidth associated with a user equipment (UE) for carrier aggregation associated with a frequency band combination; and transmitting a carrier aggregation configuration for the UE, associated with the frequency band combination, that is based at least in part on the supported aggregated bandwidth.

Aspect 15: The method of Aspect 14, further comprising: receiving one or more uplink signals in accordance with the carrier aggregation configuration.

Aspect 16: The method of any of Aspects 14-15, further comprising: transmitting one or more downlink signals in accordance with the carrier aggregation configuration.

Aspect 17: The method of any of Aspects 14-16, further comprising: receiving an indication of another supported aggregated bandwidth associated with the UE for carrier aggregation associated with another frequency band combination.

Aspect 18: The method of any of Aspects 14-17, wherein the supported aggregated bandwidth is associated with a capability of the UE.

Aspect 19: The method of any of Aspects 14-18, wherein the indication of the supported aggregated bandwidth is included in at least one of: a UE capability report, UE capability signaling, or a UE assistance information (UAI) communication.

Aspect 20: The method of any of Aspects 14-19, wherein the supported aggregated bandwidth is associated with intra-band carrier aggregation.

Aspect 21: The method of Aspect 20, wherein the intra-band carrier aggregation includes at least one of intra-band contiguous carrier aggregation or intra-band non-contiguous carrier aggregation.

Aspect 22: The method of any of Aspects 14-21, wherein the supported aggregated bandwidth is associated with inter-band carrier aggregation.

Aspect 23: The method of any of Aspects 14-22, wherein the supported aggregated bandwidth is a maximum aggregated bandwidth supported by the UE for the carrier aggregation associated with the frequency band combination.

Aspect 24: The method of any of Aspects 14-23, further comprising: receiving an indication of a bandwidth combination set (BCS) associated with the carrier aggregation associated with the frequency band combination, wherein the BCS is associated with another aggregated bandwidth for the carrier aggregation associated with the frequency band combination, and wherein the supported aggregated bandwidth is less than the other aggregated bandwidth.

Aspect 25: The method of any of Aspects 14-24, wherein the frequency band combination is associated with a carrier aggregation class, wherein the carrier aggregation class is associated with another aggregated bandwidth for the carrier aggregation associated with the frequency band combination, and wherein the supported aggregated bandwidth is less than the other aggregated bandwidth.

Aspect 26: The method of any of Aspects 14-25, wherein the carrier aggregation configuration is associated with a first carrier associated with a first bandwidth and a second carrier associated with a second bandwidth, and wherein a sum of the first bandwidth and the second bandwidth is less than or equal to the supported aggregated bandwidth.

Aspect 27: An apparatus for wireless communication at a device, comprising a processor; memory coupled with the processor; and instructions stored in the memory and executable by the processor to cause the apparatus to perform the method of one or more of Aspects 1-13.

Aspect 28: A device for wireless communication, comprising a memory and one or more processors coupled to the memory, the one or more processors configured to perform the method of one or more of Aspects 1-13.

Aspect 29: An apparatus for wireless communication, comprising at least one means for performing the method of one or more of Aspects 1-13.

Aspect 30: A non-transitory computer-readable medium storing code for wireless communication, the code comprising instructions executable by a processor to perform the method of one or more of Aspects 1-13.

Aspect 31: A non-transitory computer-readable medium storing a set of instructions for wireless communication, the set of instructions comprising one or more instructions that, when executed by one or more processors of a device, cause the device to perform the method of one or more of Aspects 1-13.

Aspect 32: An apparatus for wireless communication at a device, comprising a processor; memory coupled with the processor; and instructions stored in the memory and executable by the processor to cause the apparatus to perform the method of one or more of Aspects 14-26.

Aspect 33: A device for wireless communication, comprising a memory and one or more processors coupled to the memory, the one or more processors configured to perform the method of one or more of Aspects 14-26.

Aspect 34: An apparatus for wireless communication, comprising at least one means for performing the method of one or more of Aspects 14-26.

Aspect 35: A non-transitory computer-readable medium storing code for wireless communication, the code comprising instructions executable by a processor to perform the method of one or more of Aspects 14-26.

Aspect 36: A non-transitory computer-readable medium storing a set of instructions for wireless communication, the set of instructions comprising one or more instructions that, when executed by one or more processors of a device, cause the device to perform the method of one or more of Aspects 14-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit, to a network entity, an indication of a supported aggregated bandwidth for carrier aggregation associated with a frequency band combination; and
receive, from the network entity, a carrier aggregation configuration, associated with the frequency band combination, that is based at least in part on the supported aggregated bandwidth.

2. The UE of claim 1, wherein the one or more processors are further configured to at least one of:
transmit one or more uplink signals in accordance with the carrier aggregation configuration; or
receive one or more downlink signals in accordance with the carrier aggregation configuration.

3. The UE of claim 1, wherein the one or more processors are further configured to:
transmit, to the network entity, an indication of another supported aggregated bandwidth for carrier aggregation associated with another frequency band combination.

4. The UE of claim 1, wherein the supported aggregated bandwidth is associated with a capability of the UE.

5. The UE of claim 1, wherein the supported aggregated bandwidth is associated with intra-band carrier aggregation, wherein the intra-band carrier aggregation includes at least one of intra-band contiguous carrier aggregation or intra-band non-contiguous carrier aggregation.

6. The UE of claim 1, wherein the supported aggregated bandwidth is associated with inter-band carrier aggregation.

7. The UE of claim 1, wherein the supported aggregated bandwidth is a maximum aggregated bandwidth supported by the UE for the carrier aggregation associated with the frequency band combination.

8. The UE of claim 1, wherein the one or more processors are further configured to:
transmit, to the network entity, an indication of a bandwidth combination set (BCS) associated with the carrier aggregation associated with the frequency band combination, wherein the BCS is associated with another aggregated bandwidth for the carrier aggregation associated with the frequency band combination, and wherein the supported aggregated bandwidth is less than the other aggregated bandwidth.

9. The UE of claim 1, wherein the frequency band combination is associated with a carrier aggregation class, wherein the carrier aggregation class is associated with another aggregated bandwidth for the carrier aggregation associated with the frequency band combination, and wherein the supported aggregated bandwidth is less than the other aggregated bandwidth.

10. The UE of claim 1, wherein the carrier aggregation configuration is associated with a first carrier associated with a first bandwidth and a second carrier associated with a second bandwidth, and wherein a sum of the first bandwidth and the second bandwidth is less than or equal to the supported aggregated bandwidth.

11. A network entity for wireless communication, comprising:
a memory; and
one or more processors, coupled to the memory, configured to:
receive an indication of a supported aggregated bandwidth associated with a user equipment (UE) for carrier aggregation associated with a frequency band combination; and
transmit a carrier aggregation configuration for the UE, associated with the frequency band combination, that is based at least in part on the supported aggregated bandwidth.

12. The network entity of claim 11, wherein the supported aggregated bandwidth is associated with a capability of the UE.

13. The network entity of claim 11, wherein the indication of the supported aggregated bandwidth is included in at least one of:
a UE capability report,
UE capability signaling, or
a UE assistance information (UAI) communication.

14. The network entity of claim 11, wherein the supported aggregated bandwidth is a maximum aggregated bandwidth supported by the UE for the carrier aggregation associated with the frequency band combination.

15. The network entity of claim 11, wherein the carrier aggregation configuration is associated with a first carrier associated with a first bandwidth and a second carrier associated with a second bandwidth, and wherein a sum of the first bandwidth and the second bandwidth is less than or equal to the supported aggregated bandwidth.

16. A method of wireless communication performed by a user equipment (UE), comprising:
transmitting, to a network entity, an indication of a supported aggregated bandwidth for carrier aggregation associated with a frequency band combination; and
receiving, from the network entity, a carrier aggregation configuration, associated with the frequency band combination, that is based at least in part on the supported aggregated bandwidth.

17. The method of claim 16, further comprising at least one of:
transmitting one or more uplink signals in accordance with the carrier aggregation configuration; or
receiving one or more downlink signals in accordance with the carrier aggregation configuration.

18. The method of claim 16, further comprising:
transmitting, to the network entity, an indication of another supported aggregated bandwidth for carrier aggregation associated with another frequency band combination.

19. The method of claim 16, wherein the supported aggregated bandwidth is associated with a capability of the UE.

20. The method of claim 16, wherein the supported aggregated bandwidth is associated with intra-band carrier aggregation, wherein the intra-band carrier aggregation includes at least one of intra-band contiguous carrier aggregation or intra-band non-contiguous carrier aggregation.

21. The method of claim 16, wherein the supported aggregated bandwidth is associated with inter-band carrier aggregation.

22. The method of claim 16, wherein the supported aggregated bandwidth is a maximum aggregated bandwidth supported by the UE for the carrier aggregation associated with the frequency band combination.

23. The method of claim 16, further comprising:
transmitting, to the network entity, an indication of a bandwidth combination set (BCS) associated with the carrier aggregation associated with the frequency band combination, wherein the BCS is associated with another aggregated bandwidth for the carrier aggregation associated with the frequency band combination, and wherein the supported aggregated bandwidth is less than the other aggregated bandwidth.

24. The method of claim 16, wherein the frequency band combination is associated with a carrier aggregation class, wherein the carrier aggregation class is associated with another aggregated bandwidth for the carrier aggregation associated with the frequency band combination, and wherein the supported aggregated bandwidth is less than the other aggregated bandwidth.

25. The method of claim 16, wherein the carrier aggregation configuration is associated with a first carrier associated with a first bandwidth and a second carrier associated with a second bandwidth, and wherein a sum of the first bandwidth and the second bandwidth is less than or equal to the supported aggregated bandwidth.

26. A method of wireless communication performed by a network entity, comprising:
receiving an indication of a supported aggregated bandwidth associated with a user equipment (UE) for carrier aggregation associated with a frequency band combination; and
transmitting a carrier aggregation configuration for the UE, associated with the frequency band combination, that is based at least in part on the supported aggregated bandwidth.

27. The method of claim 26, wherein the supported aggregated bandwidth is associated with a capability of the UE.

28. The method of claim 26, wherein the indication of the supported aggregated bandwidth is included in at least one of:
a UE capability report,
UE capability signaling, or
a UE assistance information (UAI) communication.

29. The method of claim 26, wherein the supported aggregated bandwidth is a maximum aggregated bandwidth supported by the UE for the carrier aggregation associated with the frequency band combination.

30. The method of claim 26, wherein the carrier aggregation configuration is associated with a first carrier associated with a first bandwidth and a second carrier associated with a second bandwidth, and wherein a sum of the first bandwidth and the second bandwidth is less than or equal to the supported aggregated bandwidth.
